(19) United States
(12) Patent Application Publication
(10) Pub. No.: US 2013/0060918 A1
(43) Pub. Date: Mar. 7, 2013

(54) ELECTRONIC DEVICE CONTROL USING A UNIFORM RESOURCE IDENTIFIER

(71) Applicants: David G. Butler, Eagle, ID (US); Kenneth K. Smith, Boise, ID (US); Adam J. Snyder, Bend, OR (US)

(72) Inventors: David G. Butler, Eagle, ID (US); Kenneth K. Smith, Boise, ID (US); Adam J. Snyder, Bend, OR (US)

(21) Appl. No.: 13/225,815

(22) Filed: Sep. 6, 2011

(51) Int. Cl. G06F 15/177

(52) U.S. Cl. 709/220

(57) ABSTRACT

An electronic device and control method. A uniform resource identifier from a controller defines a parameter setting or value for the electronic device. The parameter setting or value is applied to the electronic device.

### BACKGROUND

Electronic input/output (I/O) devices, such as image scanners and printers for example, are often communicatively coupled to control devices, such as a computer for example. Typically a software driver is installed on the computer in order to enable communication with the I/O device. In addition, a software application that uses the software driver is also installed on the computer in order to facilitate interaction with the device by the user. Through the application and the driver, the user specifies settings or values for various operational parameters of the I/O device, and commands the I/O device to perform an I/O operation and transmit data to and from the device, such as scanning an image and providing image data to the host computer, or printing a specified data file provided by the computer to the device.

However, the software driver and software application are typically specific or custom to the particular I/O device. They are not supplied with the operating system of the computer, but rather are installed by the user in order to operate the I/O device. The installation process is often a time-consuming one, confusing to non-technical users, and fraught with pitfalls that can degrade the operation or stability of the computer if something goes wrong during the installation process. After the application and driver are installed, the user incurs a learning curve as to how to operate the I/O device. For the device manufacturer, developing and maintaining the application and driver can be a significant time and resource investment, both initially and over time. Furthermore, in order to support the I/O device on different operating systems or computers, the manufacturer typically provides a different application and driver for each operating system or computer, multiplying the time and resource investment made by the manufacturer.

### BRIEF DESCRIPTION OF THE DRAWINGS

FIG. 1 is a schematic representation of a system including a computer and an electronic device in accordance with an embodiment of the present disclosure.

FIG. 2 is a schematic representation of an example directory structure provided by the electronic device of FIG. 1 for defining parameter settings of the electronic device, in accordance with an embodiment of the present disclosure.

FIGS. 3A-C are examples of using a file system browser of a computer or controller to traverse the directory structure of FIG. 2 of an electronic device, in accordance with an embodiment of the present disclosure.

FIGS. 4A-B are examples of using a web browser of a computer or controller to traverse the directory structure of FIG. 2 of an electronic device, in accordance with an embodiment of the present disclosure.

FIG. 5 is another example of using a file system browser of a computer or controller to view and traverse the directory structure of FIG. 2 of an electronic device, in accordance with an embodiment of the present disclosure.

FIG. 6 is a flowchart of the operation of, or a method of controlling, an electronic device, in accordance with an embodiment of the present disclosure.

FIG. 7 is a schematic representation of a system including a controller and an electronic device in accordance with another embodiment of the present disclosure.

FIG. 8 is a flowchart of the operation of, or a method of controlling, an electronic device, in accordance with another embodiment of the present disclosure.

### DETAILED DESCRIPTION

Referring now to the drawings, there are illustrated examples of electronic devices, and control methods thereof, which employ a uniform resource identifier (URI) sent from an external controller, such as a computer, to the electronic device. No driver that is specific or custom to the electronic device is installed on the controller. Furthermore, in some examples, no software application specific or custom to the electronic device is installed on the controller. The URI specifies to the electronic device one or more parameter settings or values for operating the device. The electronic device parses the URI to determine the corresponding parameter settings or values, and applies them to the electronic device to perform a specified input or output operation. The URI is specified by a user, and sent from the controller to the electronic device, using a standard driver, and in some examples a standard application, that are not specific or custom to the electronic device, and that are not provided by the device manufacturer. The standard driver, and in some examples the standard application, are provided with the operating system used by the controller or are otherwise built into the controller; no installation is performed by the user. In other words, communication with the device uses the standard file operations that are provided by the operating system of the electronic controller, rather than any custom file operations. Users typically know how to interact with the standard application, for example a file system browser or a web browser, which minimizes or eliminates the learning curve for how to operate the electronic device. Device manufacturers are freed from developing and maintaining custom applications or drivers for operating the device, reducing time to market and development costs. There is little or no additional cost to the manufacturer associated with supporting the device on a different controllers or different operating systems. And for a device manufacturer who still wishes to provide a custom application or driver to, for example, provide a specific user experience or user interface are able to do so through the URI-based mechanism with reduced development effort.

As defined herein and in the appended claims, a “uniform resource identifier”, or URI, shall be broadly understood to mean a string of characters that identifies a resource, such as a data file, on a device. A URI has the following general form:

[<Protocol>]<Device ID><Pathname>

The Protocol element, which may or may not be explicitly specified in the URI, defines the manner of acting upon or obtaining the resource. Some usable protocols, as will be described subsequently in greater detail, include hypertext transfer protocol (http), file transfer protocol (ftp), common Internet file system (CIFS) protocol, server message block (SMB) protocol, and mass storage device (file) protocol, among others. The protocol typically also specifies the type of separator character(s) that may be disposed between the <Protocol>, <Device ID>, and <Pathname> elements. Typical separator characters may include “:”, “/”, “//”, “\”, and “\\”.

The Device ID element specifies the electronic device associated with the resource. Where the resource is a data file, the data may be sent to or obtained from the electronic device. The form of the Device ID element may be related to the protocol, the communication link to the electronic device, and/or the application. For example, the Device ID of a network-connected electronic device accessed via http protocol is typically an internet protocol (IP) address, such as, for example, a version 4 IP address (IPv4) such as “192.168.1.225”. As another example, the Device ID of a USB-connected device accessed via mass storage device protocol is typically a logical disk drive identifier, such as a drive letter “N”, or a mount point or directory name in the regular hierarchical file system.

The Pathname element specifies the data file. The Pathname element has the following general form:

[<Directory Path>]<Filename>[<Filetype>]

The Filename element is the name of the data file. The Filetype element, which may or may not be explicitly recited in the URI, specifies the type of the data file, which may in turn define the format of the file data. The Directory Path element, which may or may not be explicitly recited in the URI, specifies one or more directories, sub-directories, or folders associated with the filename. In devices such as disk drives, the Directory Path specifies the location of the data file in a hierarchical disk directory structure of the disk drive. According to the present disclosure, the Directory Path may additionally or alternatively be used to specify to the electronic device one or more parameter settings or values for operating the device.

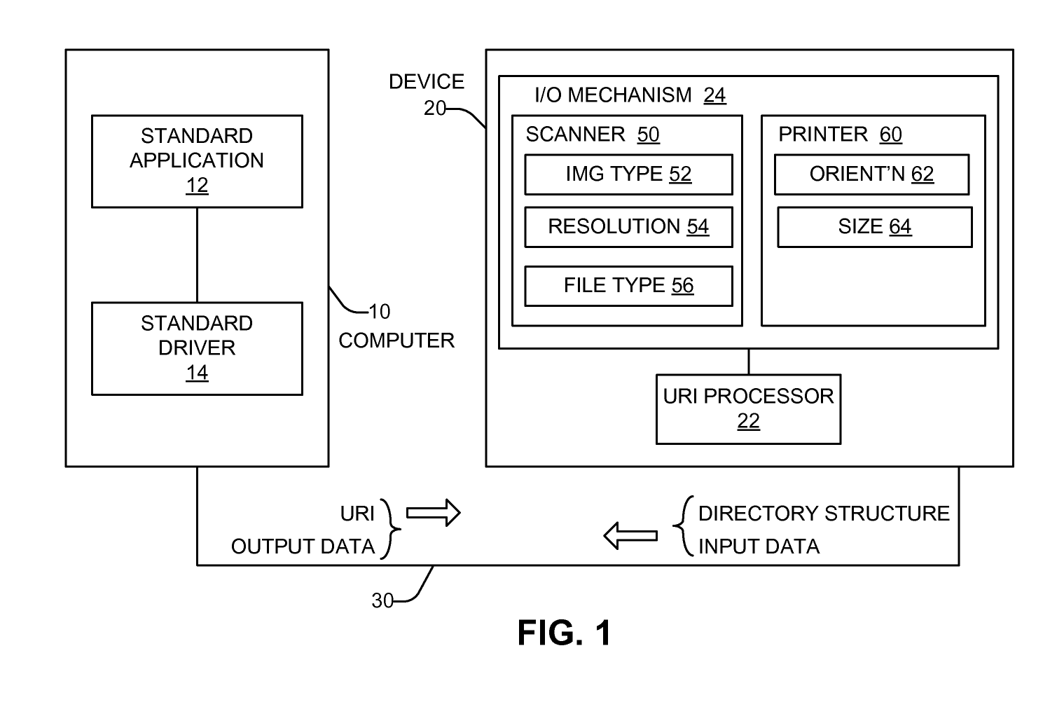

Considering now, and with reference to FIG. 1, an example system of the present disclosure, a computer 10 is communicatively coupled to an electronic device 20 via a wired or wireless communication arrangement 30. The device 20 can be one of a variety of devices such as, for example, a printer, a scanner, a fax machine, a camera, or a multifunction device that provides a combination of features, such as for example print, scan, and/or fax features, to name a few. The computer 10 may be a personal computer, host computer, client computer, notebook or laptop computer, personal digital assistant (PDA), smart phone, or intelligent consumer device, to name but a few.

At the computer 10, a user may interact with a standard application 12 of the computer 10 to traverse a directory structure provided by the device 20 so as to construct a URI that specifies to the electronic device 20 one or more parameter settings for operating the device to perform its I/O operation, and to send the constructed URI to the device 20. The computer 10 may also send output data to a device 20 with an output (or data-consuming) function such as a printer, or receive input data from a device 20 with an input (or data-acquiring) function such as an image scanner. The standard application 12 may be, for example, a file system browser or a web browser that is provided with the operating system or built into the computer 10. The standard application 12 communicates with the device 20 through a standard driver 14. The standard driver 14 may be, for example, a mass storage device driver, or a network protocol stack.

The URI constructed at the computer 10 by the user, which may alternatively be preprogrammed and/or automatically generated, is received by the device 20 via the communication arrangement 30. A processor 22 of the device 20 processes the received URI to determine the parameter settings, and applies the parameter settings to the I/O mechanism 24 of the device 20. The I/O mechanism 24 then performs the input or output operation specified by the URI according to the applied parameter settings, consuming output data provided to the device 20 by the computer 10, and/or producing input data that is provided by the device 20 to the computer 10.

In one example, the I/O mechanism 24 includes two I/O functions: an image scanner 50 and a printer 60. The image scanner function 50 optically scans a document and generates a stream of data corresponding to an image of the document. The example image scanner 50 has a plurality of settable parameters, three of which are: an image type 52, a scan resolution 54, and a file type 56.

An image scan is conducted in accordance with the current settings or values of these parameters. The image type parameter 52 specifies whether the scanned image data is color data or monochrome data and, in one example, can assume a setting or value of Color or Mono. The scan resolution parameter 54 specifies the resolution of the scanned image data in dots per inch, and can assume a setting or value of 300 dpi, 600 dpi, or 1200 dpi. The file type parameter 56 specifies the data format in which the scanned image data is provided to the computer, and can assume a setting or value of JPG format, PDF format, or PNG format.

The printer function 60 receives a document to be printed and produces a hardcopy of the document on media such as paper. The example printer 60 has a plurality of settable parameters, two of which are media orientation 62 and media size 64. The media orientation 62 parameter specifies the orientation in which the print data is to be printed on the media and, in one example, can assume a setting or value of Portrait orientation or Landscape orientation. The media size 64 parameter specifies the size of the sheet of media on which the print data is to be printed and, in one example, can assume a setting or value of Letter-size media or A4-size media.

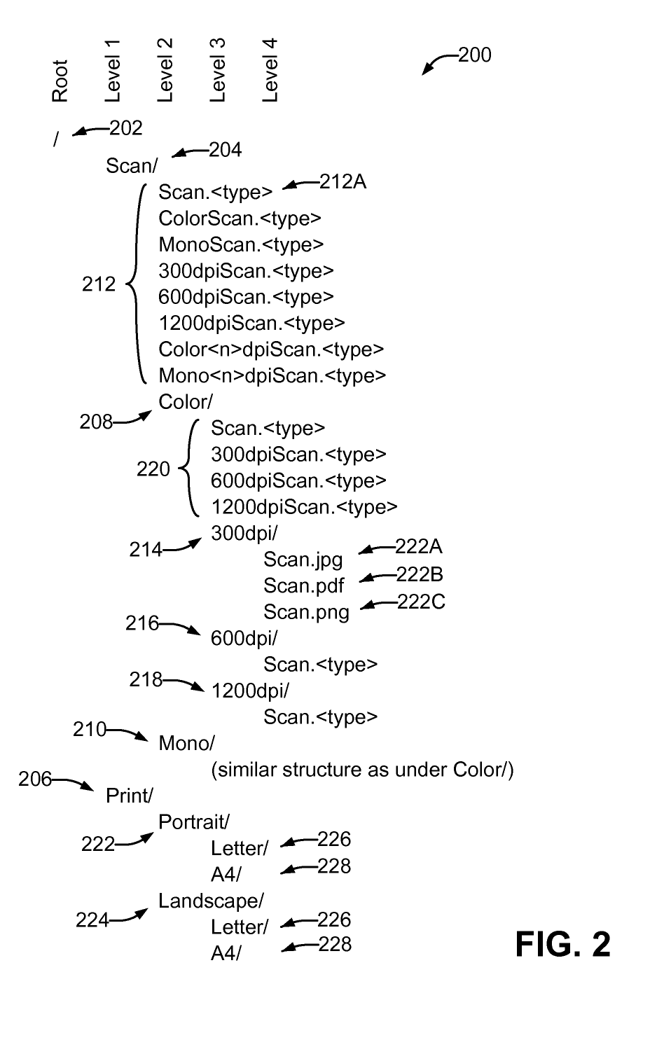

Considering now in greater detail the directory structure provided by the example electronic device 20, and with reference to FIGS. 1 and 2, the directory structure 200 is a hierarchical tree structure. The structure is illustrated in FIG. 2 in an indented textual form, where the levels of indentation correspond to levels of the tree, denoted as Root through Level 4. The directory structure 200 corresponds to the set of valid or allowable Pathnames for the device 20. The directory structure 200 begins at a Root level node 202, denoted as “/”. At the Root level node 202, the tree has branches to two child nodes at Level 1: Scan/ node 204 and Print/ node 206.

A node can generally be considered to be one of two types: parent nodes and end nodes. A parent node has branches to one or more child nodes. An end node does not branch to any child nodes; instead, it is a terminal node. With regard to the tree structure of disk drives, a parent node is a directory (or alternatively, a sub-directory or a folder). An end node may be a childless directory or a file. In disk drive parlance, child nodes may be referred to as the “contents” of their parent node or directory.

The Scan/ directory 204 at Level 1 contains a number of child nodes at Level 2. First, the Scan/ directory 204 has child directory nodes Color/ 208 and Mono/ 210, both of which are parent nodes in turn. As parent nodes, nodes 208, 210 at Level 1 are directories that lead to lower-level nodes at Level 2.

Second, the Scan/ directory 204 has child end nodes indicated collectively at 212. In this example, each of the individual nodes 212 is in a Filename plus Filetype format. To simplify illustration, the end nodes 212 are presented in abbreviated form. For example, the node “Scan.<type>” 212a is to be understood as representing a plurality of nodes, one for each value of <type>. If the image file data can be in one of three formats—.jpg, .pdf, or .png, for example—then “Scan.<type>” is shorthand for three nodes: “Scan.jpg”, “Scan.pdf”, and “Scan.png”. Similarly, the notation “<n>” in e.g. the node “Color<n>dpiScan.<type>” is to be understood as representing a plurality of nodes, one for each allowable value of scan resolution: 300 dpi, 600 dpi, and 1200 dpi for example. Thus the node “Color<n>dpiScan.<type>” is to be understood as representing a total of nine nodes when the values of <n> and <type> are fully expanded out.

The Color/ directory 208 at Level 2, in turn, has several child nodes at Level 3 which in turn are parent nodes (directories): 300 dpi/ 214, 600 dpi/ 216, and 1200 dpi/ 218. The Color/ directory 208 also has several end nodes indicated collectively at 220 in Filename plus Filetype format.

The 300 dpi/ directory 214 at Level 3, in turn, has three child nodes 222A-C at Level 4, each of which is an end node in Filename plus Filetype format.

Although not illustrated for simplicity, it is to be understood that the Mono/ directory 210 at Level 2 may replicate the same structure at Levels 3 and 4 that exists for the Color/ directory 208.

An analogous but simpler structure exists under the Print/ directory 206. The Print/ directory 206 at Level 1 has two child nodes at Level 2, which in turn are each parent nodes (directories): Portrait/ 222 and Landscape/ 224. Each of these Level 2 nodes in turn has two child nodes at Level 3: Letter/ 226 and A4/ 228. Nodes 226, 228 are directory nodes and also end nodes. In this case there are no end nodes in Filename plus Filetype format under the Print/ directory 206, for reasons as will be explained subsequently.

It can be appreciated from the above that each node of the directory structure 200 of FIG. 2 at Level 2-4 corresponds to a value or setting for one or more of the parameters 52-56, 62-64 of the I/O mechanism 24 of FIG. 1. The nodes at Level 1, in this example, specify the particular I/O mechanism of this multi-function electronic device 20. In a single-function electronic device, such as a scanner, the Scan/ node can be omitted, and the Level 2-4 nodes for the scanner moved up to Levels 1-3 resulting in a shorter URL.

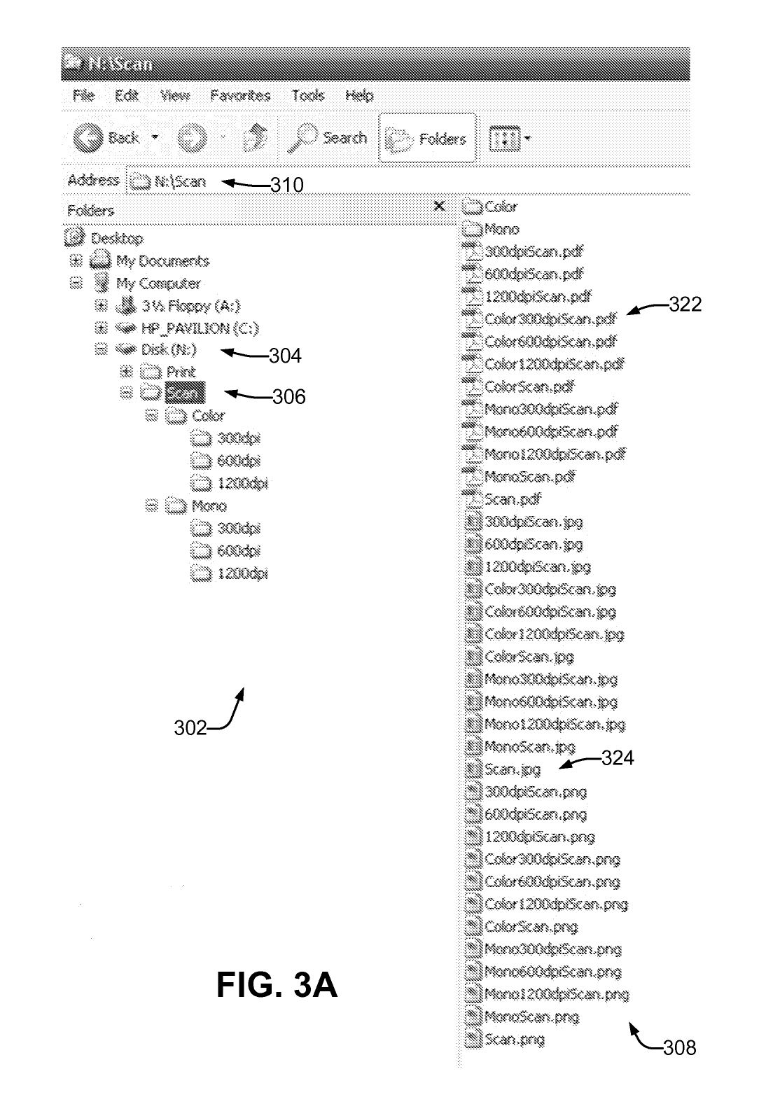

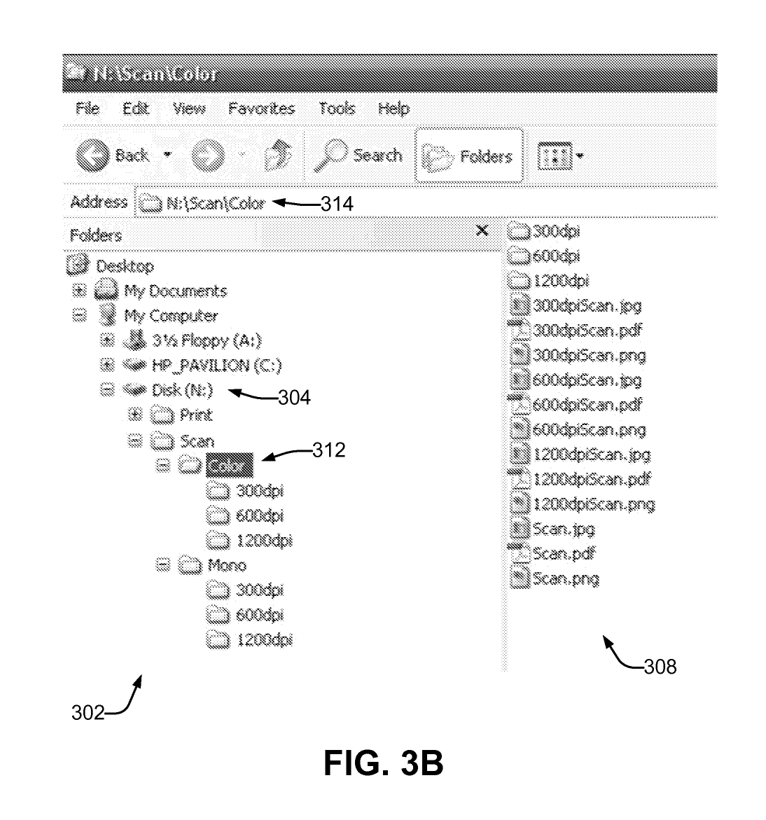

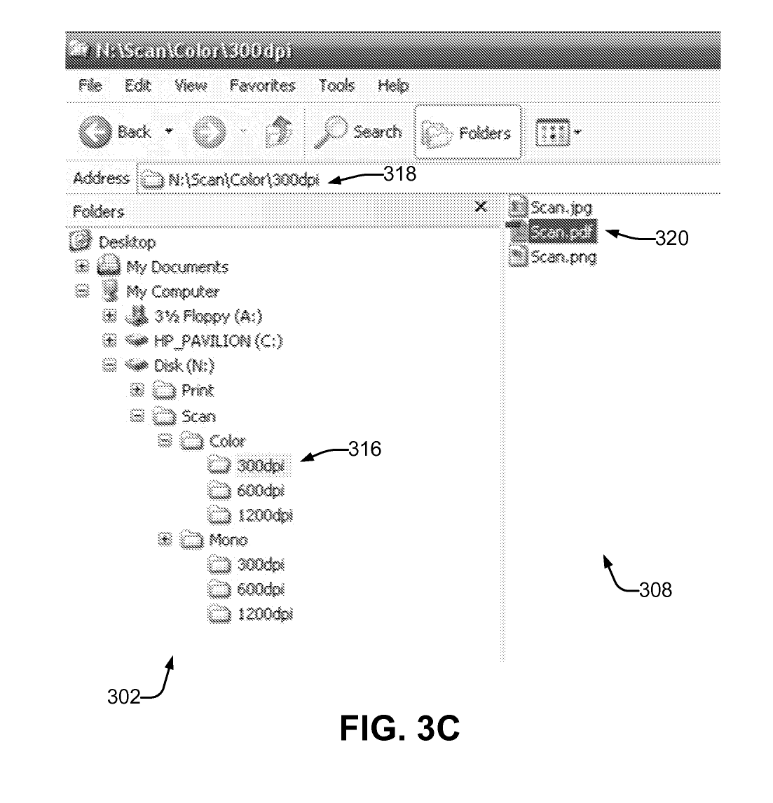

Considering now in greater detail the traversal of an example directory structure to construct a URI, and with reference to FIGS. 3A-C, the figures illustrate a directory structure of an electronic device as viewed and traversed using a file system browser. In one example, the electronic device is the electronic device 20 of FIG. 1, the computer is the computer 10 of FIG. 1, the file system browser is the standard application 12 of FIG. 1, and the directory structure is the directory structure 200 of FIG. 2.

The electronic device 20 and its directory structure 200 may be displayed in a folders region 302 of the browser display. The folders region 302 can display devices and folders in collapsed (“−”) or expanded (“+”) form. The electronic device 20 appears as “Disk (N:)” 304. The levels of the directory structure of the device 20 are illustrated in indented form (compressed or expanded) below Disk (N:) 304. The Print directory 304 is collapsed, while the Scan directory 306 is expanded at all levels to illustrate the directory structure below the Scan directory 306. In some examples, a URI may be constructed by traversing the directory structure.

FIG. 3A illustrates the browser display when the Scan directory 306 is selected for display. The files region 308 displays the files and directories contained in the Scan directory 306, which correspond to the files and directories contained in the Scan/ directory 204 of FIG. 2. A URI 310 of “N:\Scan” is displayed in the Address bar and corresponds to the selection of the Scan directory 306.

FIG. 3B illustrates the browser display when the Color directory 312 beneath the Scan directory 306 is selected for display. The files region 308 displays the files and directories contained in the Color directory 312, which correspond to the files and directories contained in the Color/ directory 208 of FIG. 2. A URI 314 of “N:\Scan\Color” is displayed in the Address bar and corresponds to the selection of the Color directory 312.

FIG. 3C illustrates the browser display when the 300 dpi directory 316 beneath the Color directory 312 is selected for display. The files region 308 displays the files and directories contained in the 300 dpi directory 316, which correspond to the files and directories contained in the 300 dpi/ directory 214 of FIG. 2. A URI 318 of “N:\Scan\Color\300 dpi” is displayed in the Address bar and corresponds to the selection of the 300 dpi directory 316.

While FIGS. 3A-C illustrate the URI as constructed by traversing the directory structure, in other examples the URI may be pre-formed in a custom application, or pre-printed in user documentation and entered directly by the user into the browser.

An I/O operation for the electronic device 20 may be specified by selecting a particular file in a folder (e.g. by double-clicking the file). The Filename and Filetype of the selected file are appended to the URI illustrated in the Address bar, and the fully-constructed URI is then sent to the electronic device 20 to configure the device 20 with the desired settings or values for its parameters, and initiate the requested I/O operation for the device 20.

As one example, assume that the user selects the “Scan.pdf” file 320 in the files region 308 of FIG. 3C. The following URI will be sent to the electronic device 20:

N:\Scan\Color\300 dpi\Scan.pdf

This URI has a Device ID of “N:”, and a Pathname of “Scan\Color\300 dpi\Scan.pdf”. The Pathname, in turn, has a Directory Path of “Scan\Color\300 dpi\” with three Directories, a Filename of “Scan”, and a Filetype of “pdf”.

As another example, assume that the user selects the “Color300 dpiScan.pdf” file 322 in the files region 308 of FIG. 3A. The following URI will be sent to the electronic device 20:

N:\Scan\Color300 dpiScan.pdf

This URI has a Device ID of “N:”, and a Pathname of “Scan\Color300 dpiScan.pdf”. The Pathname, in turn, has a Directory Path of “Scan\” with one Directory, a Filename of “Color300 dpiScan”, and a Filetype of “pdf”.

The electronic device 20 receives the URI and parses the text characters of the Pathname to determine the specified settings for the parameters of the device 20. Both of these example URIs are directed to the scanner function 50 of the device 20, as denoted by the first directory “Scan\”, and both specify the same scanner parameter settings. In the first example, “Color” and “300 dpi” are specified as separate Directories, while in the second example they are specified in the Filename. The device 20 sets the image type 52 to “Color”, the scan resolution 54 to “300 dpi”, and the file type 56 to “pdf”. The text “Scan” as the Filename of both URIs specifies that the scanner 50 is to perform an image scan operation and stream the image data to the computer 10.

In both examples above, the URI explicitly specifies the settings for all parameters. However, a URI may also specify one or more settings implicitly. For example, assume that the user selects the “Scan.jpg” file 324 in the files region 308 of FIG. 3A. The following URI will be sent to the electronic device 20:

N:\Scan\Scan.jpg

This URI has a Device ID of “N:”, and a Pathname of “Scan\Scan.jpg”. The Pathname, in turn, has a Directory Path of “Scan\” with one Directory, a Filename of “Scan”, and a Filetype of “jpg”. The electronic device 20 receives the URI and parses the text characters of the Pathname to determine the specified settings for the parameters of the scanner function 50 of the device 20. The file type 56 parameter is set to “jpg”, as specified explicitly. However, the URI does not explicitly specify settings for the image type 52 or scan resolution 54 parameters. In this situation, the electronic device 20 may use predefined default settings for these parameters, or may use the most recently specified settings for these parameters. The text “Scan” in the Filename of the URI specifies that the scanner 50 is to perform an image scan operation and stream the image data to the computer 10.

The electronic device 20, in providing the directory structure 200 to the computer 10, determines which files are contained in each directory of the structure 200. For example, while the files region 308 of FIG. 3A illustrates an exhaustive set of files for all possible parameter combinations, the device 20 may instead choose to provide a fewer number of files, or no files at all, at the Scan level. As a result, the user will further traverse the directory structure 200, explicitly specifying parameter settings in the process, until locating a file which can be selected to send a constructed URI to the device 20 and initiate its operation.

While the directory structure may be hierarchical, the corresponding settings may not be. In the example electronic device 20, it would not matter whether the Directory Path is specified as “Color\300 dpi\” or “300 dpi\Color\”, since the image type 52 parameter and the scan resolution 54 parameter are independent of each other. In addition, the text of the Pathname, while illustrated as words which convey the meaning of a parameter setting to the user, may also be abbreviated or even unrelated to the parameter or its setting. For example, instead of “Color”, the directory structure 200 could present “C” or even “T34” as the corresponding directory or filename to the user.

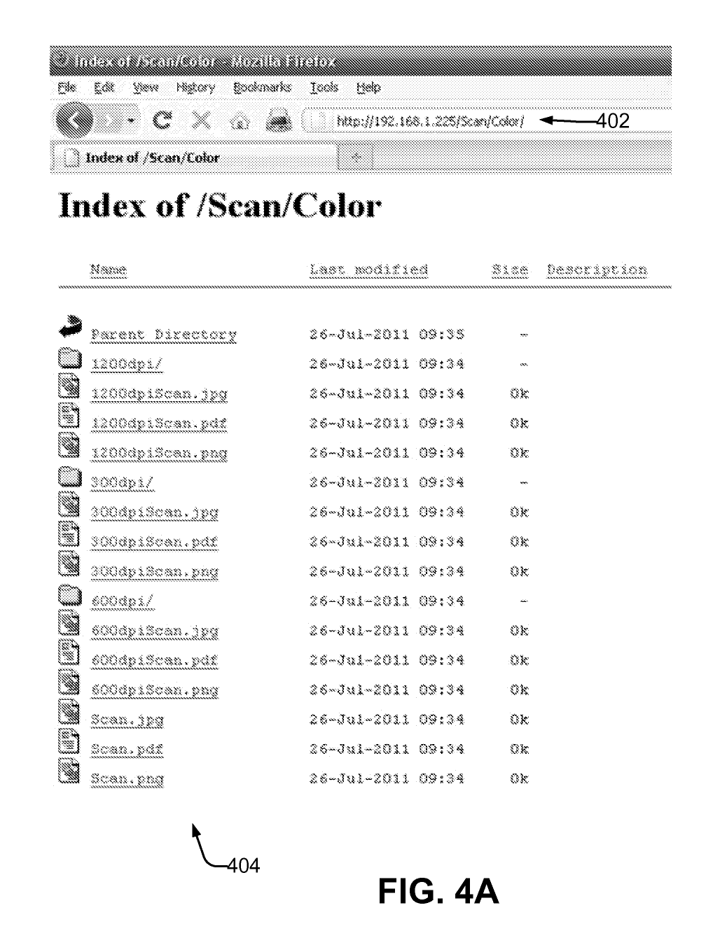

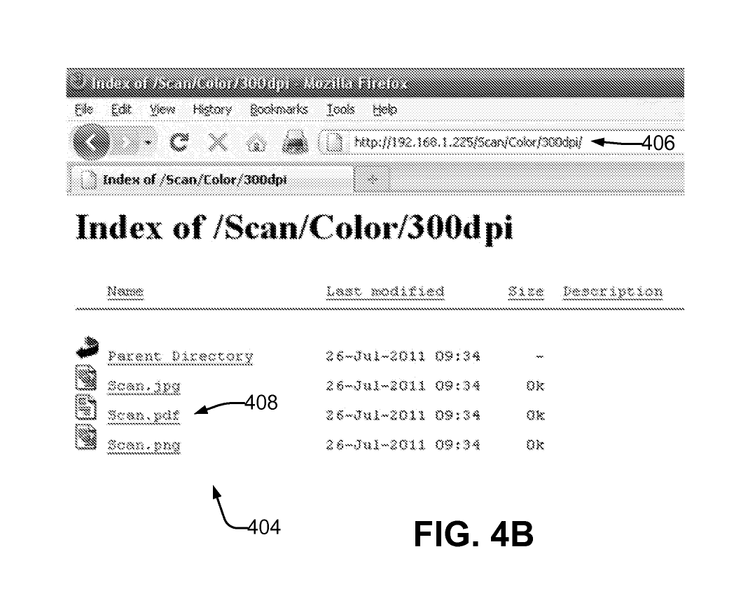

Considering now the traversal of a directory structure to construct a URI via a web browser, and with reference to FIGS. 4A-B, the web browser may be the standard application 12 of FIG. 1 instead of the file system browser. Many computers, including traditional computers but also smart phones, PDAs, consumer electronic devices, and the like, provide or support a web browser. The web browser can be used to communicate with electronic devices 20 which are network-connected.

FIG. 4A illustrates the browser display where the user has navigated to the Color/ directory 208 of FIG. 2. The Address bar shows the corresponding URI 402:

http://192.168.1.225/Scan/Color/

The Protocol field is “http”, indicating that the web browser is communicating with the electronic device 20 via hypertext transfer protocol. The Device ID field indicates the IPv4 address of 192.168.1.225 for the device 20. The Pathname is a Directory Path of “Scan/Color/”. A files region 404 displays the files and directories contained at this Directory Path, which correspond to the files and directories contained in the Color/ directory 208 of FIG. 2.

Each of the files and directories in the files region 404 are hyperlinks. Selecting (e.g. clicking on) the hyperlink for the directory “300 dpi/” navigates to that child directory, and presents the browser display of FIG. 4B. The Address bar displays the corresponding URI 406:

http://192.168.1.225/Scan/Color/300 dpi/

In addition, the browser displays the files and directories contained at the Directory Path of “Scan/Color/300 dpi/”.

An I/O operation for the electronic device 20 may be specified by selecting one of the file in a folder. As an example, assume that the user selects the “Scan.pdf” file 408 in the files region 404 of FIG. 4B. The Filename (Scan) and Filetype (pdf) of the selected file are appended to the URI illustrated in the Address bar to form the following fully-constructed URI:

http://192.168.1.225/Scan/Color/300 dpi/Scan.pdf

This fully-constructed URI is then sent to the electronic device 20 (for example, within an HTTP GET request) to configure the device 20 with the desired settings or values for its parameters, and initiate the requested I/O operation for the device 20, in a similar manner as has been described heretofore.

It is also noted that, in many file system browsers and web browsers, the user may construct the URI in a manner other than by selecting directories to iteratively traverse the directory structure. For example, the user may directly type the URI into the Address field of a browser. As another example, the user may recall a previously-constructed URI that was saved as a bookmark.

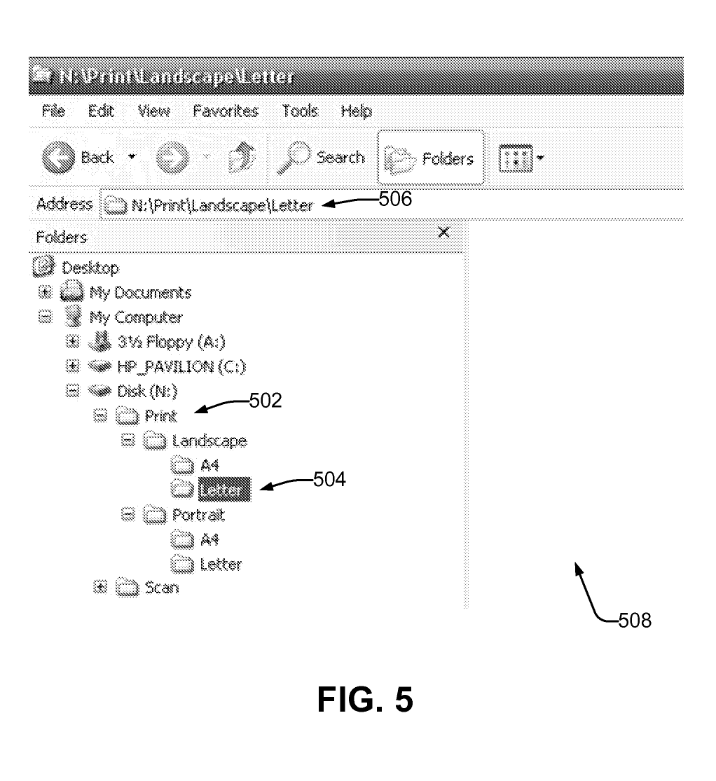

The directory structure traversals discussed heretofore with reference to FIGS. 3A-C and 4A-B involve the device 20 performing an input operation, image scanning. The device 20 may also perform an output operation, such as printing for example. Considering now the traversal of a directory structure to perform an output operation, and with reference to FIG. 5, a file system browser displays the subdirectories of a Print directory 502. A Letter directory 504 is selected, and the corresponding URI 506 “N:\Print\Landscape\Letter” is displayed in the Address bar.

It is noted that there are no files (and no child directories) in the files region 508 of the browser display that the user can select to initiate the print operation. Instead, to print a file, the user can copy-and-paste, or drag-and-drop, the file that is to be printed into the desired directory. For example, if the user pastes a file “PrintData.pdf” into the Letter directory 504 in the file system browser, the file “PrintData.pdf” is sent to the device 20 along with the URI 506 “NAPrint\Landscape\Letter”.

The electronic device 20 receives the URI and parses the text characters of the Pathname to determine the specified settings for the parameters of the device 20. The orientation parameter 62 of the printer 60 is set to “Landscape”, and the media size parameter 64 is set to “Letter”. The device 20 then prints the file “PrintData.pdf” in landscape orientation on letter-size media in accordance with the parameter settings.

A web browser may also be used to perform an output operation. In one example, a user specifies a URI that includes a Filename of, for example, “Print.html”. An HTML-based form corresponding to the filename is retrieved and displayed by the web browser. The file to be printed (output) is specified in a field on the form, and then the corresponding file is sent to the device 20 (via, for example, an HTTP PUT or POST command).

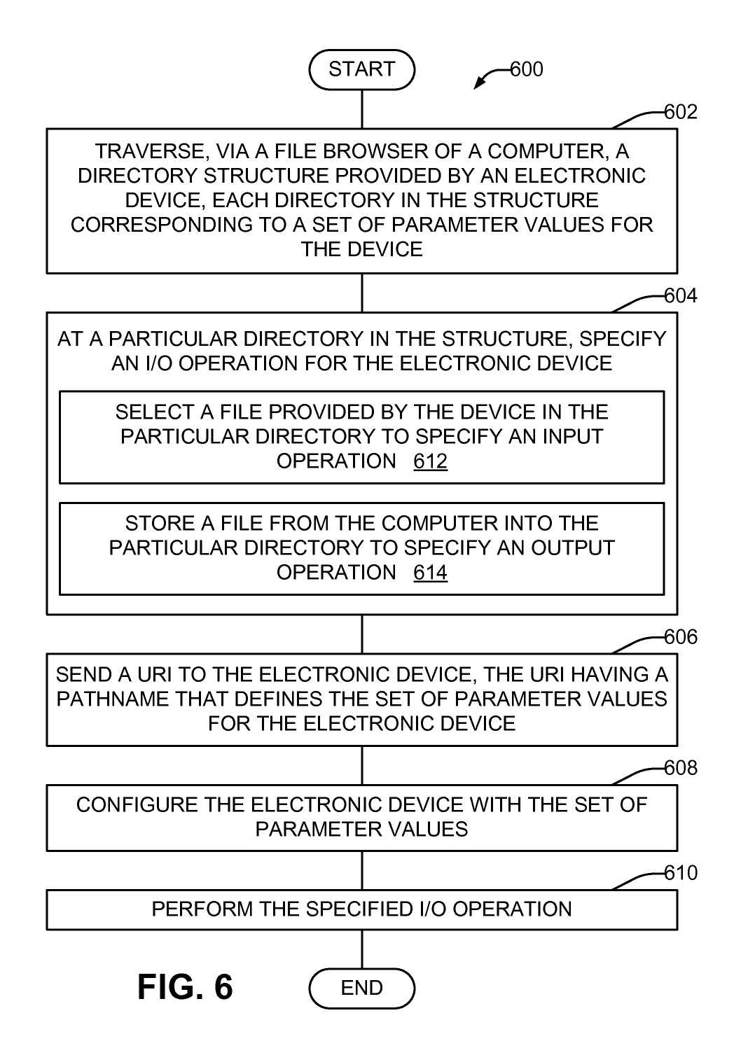

Consider now, and with reference to FIG. 6, a flowchart of the operation of an electronic device. Alternatively, the flowchart of FIG. 6 may be considered as steps in a method of controlling an electronic device. A method 600 begins at 602 by traversing, via a browser of a computer, a directory structure provided by the electronic device, where each directory in the structure corresponds to a set of parameter settings or values for the electronic device. The set may contain one or more parameter settings or values. For example, the Scan directory 306 (FIG. 3) corresponds to selecting the scanner 50 for the function of the I/O mechanism 24, the Color setting for the image type parameter 52, and the 300 dpi setting for the scan resolution parameter 54. At 604, at a particular directory in the structure, an I/O operation for the electronic device is specified. In some examples, a file provided by the electronic device in the particular directory of the directory structure is selected at 612 in order to specify an input operation. In some examples, a file from the computer is stored into the particular directory of the directory structure at 614 in order to specify an output operation.

At 606, a URI is sent to the electronic device in response to the specifying. The URI has a path that defines the set of parameter values or settings for the electronic device. At 608, the electronic device is configured with the set of parameter values, and then the specified I/O operation is performed in accordance with the set of parameter values. Where the operation is an input operation, the device may stream a file of data back to the computer. Where the operation is an output operation, a data file may be provided to the electronic device along with, or in addition to, the URI.

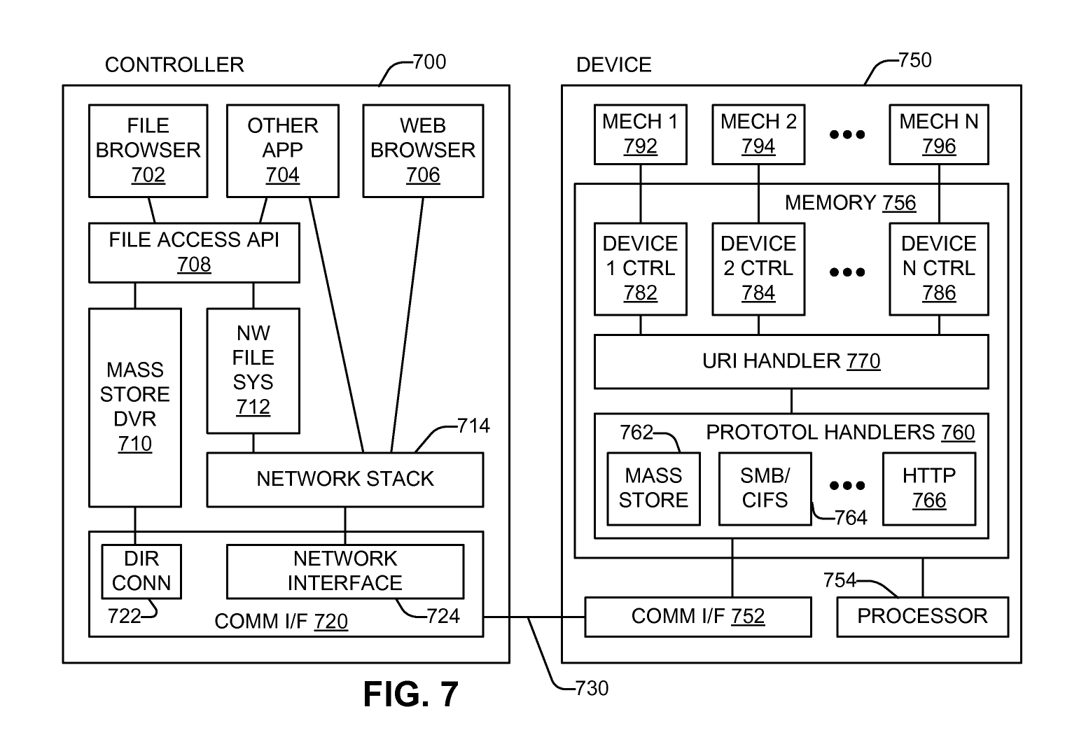

Considering now, and with reference to FIG. 7, another example system of the present disclosure, a controller 700 is communicatively coupled to an electronic device 750 via a wired or wireless link 730. The controller 700 may be a personal computer, host computer, client computer, notebook or laptop computer, personal digital assistant (PDA), smart phone, or intelligent consumer device, to name but a few. The controller 700, which in some examples may be interactively controlled by a user, controls an input or output operation or function of the electronic device 750. The device 750 can be one of a variety of devices such as, for example, a printer, a scanner, a fax machine, a camera, or a multifunction device that provides a combination of print, scan, and/or fax features, to name a few. The link 730 may be any wired or wireless mechanism usable to couple the controller 700 and the device 750. The link 730 is established between a communication interface 720 of the controller 700 and a complementary communication interface 752 of the device 750. The interfaces 720, 752 may provide a direct connection or a networked connection between the controller 700 and the device 750. An interface 720, 752 may be a universal serial bus (USB) interface, an IEEE 1394 (Firewire) interface, an eSata (external serial advanced technology attachment) interface, a wired Ethernet or TCP/IP network interface, a wireless (e.g. WiFi) network interface, or a SCSI interface, to name but a few. Data packets corresponding to a directory structure and input data from the device 750 are transmitted from the device 750 to the controller 700 via the interfaces 720, 752 over the link 730. Data packets corresponding to a constructed URI and output data from the controller 700 are transmitted from the controller 700 to the device 750 via the interfaces 720, 752 over the link 730.

A user can interact with the user interface of one or more applications on the controller 700 in order to control the electronic device 750, in a similar manner as has been discussed heretofore. One such application is a file system browser 702, as has been discussed with reference to FIGS. 3A-C. Another application is a web browser 706, as has been discussed with reference to FIGS. 4A-B. Other applications 704 may be provided for this purpose as well. Some of these applications may be standard ones, such as a file transfer protocol (ftp) client or a command-line interface. Others may be applications that are custom to the electronic device 750, such as an application provided by the manufacturer of the device 750. Still other applications 704 may be provided that automate control of the device 750 partly or totally without user input.

The file system browser 702 (and some other applications 704) communicate with a file access API (application programming interface) 708. The file access API 708 allows the file system browser 702 to open, read, write, and close files on the electronic device 750. The file access API 708, in turn, communicates with different components or modules of the controller 700 depending on the type of interface 720. For non-network connections such as USB or Firewire, the interface 720 includes a direct connection interface 722 that is typically uses a wired link 730 to the device 750. A mass storage driver 710 between the file access API 708 and the direct connection interface 722 implements Mass Storage Device protocol which accesses the electronic device 750 as though it were a disk drive having a file system. This may be implemented, for example, using a subset of the SCSI command set. The mass storage driver 710 also transfers data packets between the controller 700 and device 750 that correspond to data blocks on the disk, such as for example disk sectors. For network access such as via Ethernet, TCP/IP, or WiFi, the interface 720 includes a network interface 724 that utilizes a wired or wireless link 730 to the device 750. A network stack 714 provides a standard manner of interfacing to the network such as, for example, a sockets API for a TCP/IP protocol stack. A network file system 712 between the file access API 708 and the network stack 714 implements SMB or CIFS protocol which accesses the electronic device 750 as though it were a networked disk drive having a file system.

The web browser 706 (and some other applications 704) typically implement http protocol and act as an http client, communicating over the network interface 720 to the electronic device 750, which acts as an http server. The web browser 706 communicates directly with the network stack 714, typically via the sockets API, to send http GET, PUT, POST, etc. commands to the device 750.

At the electronic device 750, the communication interface 752 supports one or more of the network and non-network connections. The electronic device 750 includes one or more I/O mechanisms or functions, such as I/O mechanisms 792-796. Each mechanism is associated with one or more data-consuming or data-acquisition I/O functions of the device 750 such as image scanning, printing, faxing, and the like. The electronic device 750 includes one or more protocol handler modules 760, a URI handler module 770, and a device control module 782-786 for each of the corresponding I/O mechanisms 792-796. The modules 760, 770, 782-786 may be implemented in hardware, firmware, software, or a combination of these technologies. In one example, some or all of these modules are software or firmware stored in at least one memory 756. A processor 754 coupled to the memory 756 executes the software or firmware instructions in order to perform the functions of the modules.

Data packets are received from or sent to the communications interface 752 by a protocol handler 760. The device 750 may include a number of different protocol handlers 760. The protocol handlers 760 define the communication protocols by which the device 750 may be accessed by the controller 700. For example, the device 750 may include a mass storage device protocol handler 762, a SMB and/or CIFS protocol handler 764, and an http handler 766, as well as others (not shown) such as an ftp handler. The mass storage device protocol handler 762 presents the device 750 to the controller 700 as a directly connected disk drive. The SMB and/or CIFS protocol handler 764 presents the device 750 to the controller 700 as a file server. The http handler 766 presents the device 750 to the controller 700 as an http (web) server. An ftp handler presents the device 750 to the controller 700 as an ftp server.

As has been described heretofore, the controller 700 constructs a URI and sends it to the device 750 to perform an I/O operation. While the precise form of the URI is dependent on the protocol and the communication interface used to transmit it, the various protocol handlers 760 convert the data packets of the Pathname of the URI into textual, such as Unicode, form and hand off the Pathname to the URI handler 770.

The URI handler 770 parses the text of the Pathname to determine the I/O mechanism 792-792 corresponding to the Pathname, and to determine one or more particular parameter settings for that I/O mechanism. For example, consider the Pathname “Scan\Color\300 dpi\Scan.pdf”. Assume that the I/O mechanism 794 is an image scanner. In parsing the text of the Pathname, the URI handler 770 determines that the highest-level directory in the Pathname, “Scan\”, specifies the scanner mechanism 794. The URI handler 770 further determines that the Pathname also contains “Color\” and “300 dpi\” directories of the Pathname, and a Filetype “pdf”, all of which are parameter settings. The URI handler 770, or the device control module 784 associated with the scanner mechanism 794, determines the identity of the parameter and the specific setting or value to be assigned to the parameter. Thus, it is determined that the directory “Color\” specifies that the image type is to be set to color; that the directory “300 dpi\” specifies that the scan resolution is to be set to 300 dpi, and that the Filetype “pdf” specifies that the image data is to be streamed to the controller 700 in pdf format. The device control module 784 then applies these parameter settings to the I/O mechanism 794, and controls the I/O mechanism 794 to perform its associated function—in this example, scanning an image and acquiring image data, and providing that data in pdf format. The acquired image data is then streamed by the protocol handler 760 over the link 730 to the controller 700.

In one example, the URI handler 770 includes a parser that tokenizes the text of the URI, applying an algorithm for matching tokens within the URI to configurable parameters within the device subsystem. The URI handler 770 may delegate the token matching to one or more functional subsystems within the device. While the basic format of the URI is fixed, the relative positions of parameter tokens within the URI may be dynamic and unspecified. For example, “300 dpi” may appear as a directory element, or it may appear within the filename itself. The parser may expect “300 dpi” at a particular place in the URI, or may search the entire URI string for a valid parameter specification, In some examples, the parser applies a voting algorithm if multiple occurrences of the same parameter exist within a single URI. This enables highly dynamic virtual file system structures for the device that are flexible and readily adaptable to different usage models and user preferences. In some examples, the URI handler 770 can be modularized such that additional handlers can be registered to either handle a particular class of URI's, or to serve as filters for particular parameters.

Analogous operations are performed in the case of data-consuming (output) I/O mechanisms, such as a printer. The print data is received over the link 730 from the controller 700, and provided by the appropriate protocol handler 762-766 to the device control module 782-786 corresponding to the output I/O mechanism 792-796.

The electronic device 750 is also configured to provide a directory structure to the controller 700 via the link 730 so that a user can traverse the directory structure using the file system browser 702 or the web browser 706. In one example, the structure may be the directory structure 200 (FIG. 2). The entire structure may be statically predefined in the device 750. The structure may alternatively be constructed dynamically, level-by-level; in other words, when a particular level in the structure is accessed, the child directories and files for that level may be dynamically generated by the device 750. This allows for either a fixed set of choices at each level in the traversal, or a dynamically adapting set of choices based on the previous choice. For example, the level below Scan could expose all available scan parameters as choices (e.g. Color or Mono, the various dpi choices, and the various filetypes). Selecting any of these could then eliminate mutually exclusive choices from the next level, and present the remaining subset. This enables automatic dynamic directory presentation based on a set notation of available parameters without any inherent notion of hierarchy.

The directory structure may be provided or generated by the URI handler 770, by a device control module, or by a combination of the URI handler 770 and the device control module. For example, the URI handler 770 may provide or generate the entries in a top-level directory that corresponds to the particular I/O function (i.e. to I/O mechanism 792-796), while the corresponding device control module 782-786 may provide or generate the entries for lower-level directories. As has been explained heretofore, the directories and the files correspond to permissible parameter settings for the electronic device 750 that can be communicated from the controller 700 as a URI.

Where the directory structure is generated dynamically, it can respond to run-time conditions of the electronic device 750; to the addition to or removal from the electronic device of certain capabilities; or to user preferences. For example, a print output device may eliminate the Color folder from its Print directory if a particular colorant is depleted or unavailable, or if a given user (in a network file system case) doesn't have permission to print in color. Similarly, the 1200 dpi scan folder may be eliminated if the device is in a low-memory state with insufficient memory to perform a scan operation at that resolution.

Regardless of whether the directory structure is static or dynamic, it is typically provided to the controller 700 in a hierarchical manner, where a URI of a given level in the directory structure is sent to the device 750, and the device 750 returns the contents of that level to the controller 700. For example, the file system browser 702 or web browser 706 may provide to the device 750 the URI of the Root level, and in response receive the Level 1 child directories and files that are contained at the Root level. Next the browser 702, 706 may provide a URI for one of the directories at Level 1, and in response receive the Level 2 child directories and files that are contained at Level 1. Similar operation has been described heretofore with reference to FIGS. 3A-C and 4A-B.

Different electronic devices, even of the same type, may have different features. For example, one scanner device may have an automatic document feeder (ADF) and the ability to provide image data in pdf format, while another scanner device may be a flatbed scanner that lacks an ADF and cannot provide image data in pdf format. It is possible for a user to provide a URI that contains parameter settings that the electronic device does not support. For example, when working with such a flatbed scanner he may type a URI into a web browser that includes an ADF parameter setting, or may have bookmarked such a URI when previously working with a different scanner that included an ADF. The electronic device, upon receiving the URI, may simply ignore the ADF parameter setting but apply the other parameters. Conversely, if the URI requests image data in a format that the scanner does not support, may generate an error such as, for example, a “File Not Found” error. Similarly, a feature in a device may become inoperative over time. For example, if there is no paper in the ADF to be scanned, the ADF folder could be dynamically removed from the file hierarchy presented to the user by the device.

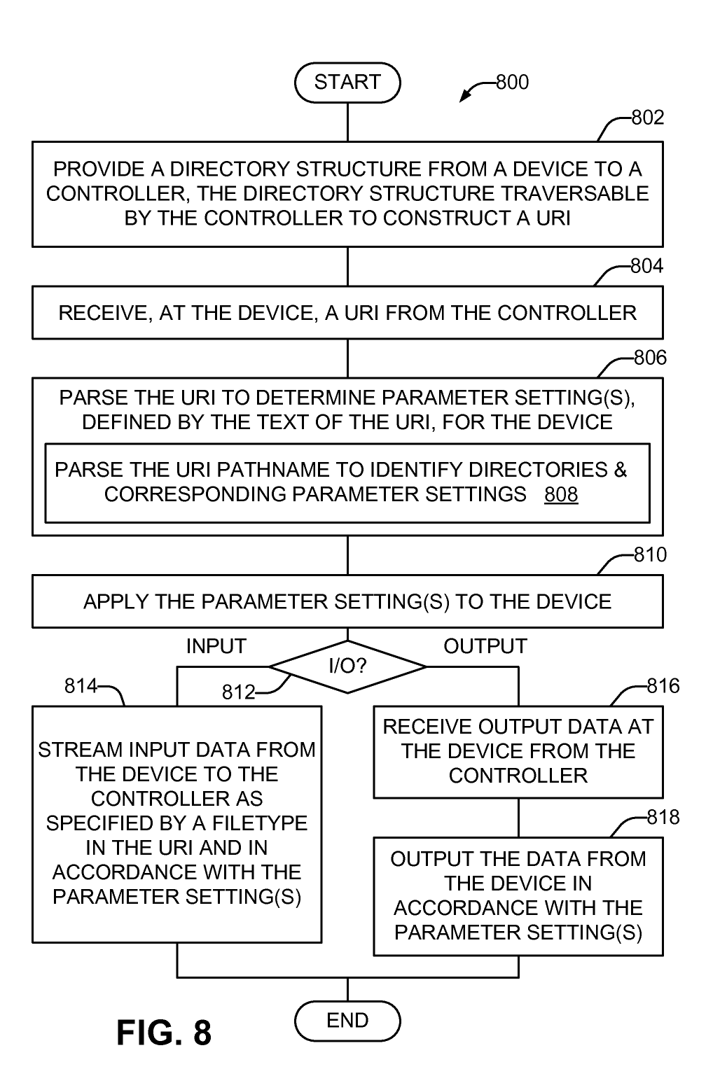

Consider now, and with reference to FIG. 8, a flowchart of the operation of an electronic device. Alternatively, the flowchart of FIG. 8 may be considered as steps in a method of controlling an electronic device. A method 800 begins at 802 by providing a directory structure from an electronic device to an external controller, the directory structure traversable by the controller to construct a URI. At 804, the electronic device receives a URI from the controller. At 806, the device parses the received URI to determine at least one parameter setting for the electronic device that is defined by the text of the URI. At 808, in some examples, the Pathname of the URI may be parsed to identify at least one Directory in the Pathname, and parameter settings that correspond to the Directories. In some examples, the Pathname may be parsed to identify a Filename or Filetype in the Pathname, and parameter setting(s) that correspond to the Filename or Filetype. At 810, the at least one parameter setting is applied to the electronic device. At 812, it is determined whether the URI specifies an input operation or an output operation. If an input operation, then at 814 input data is streamed from the electronic device to the controller in a format specified by the URI and in accordance with the applied parameter setting(s). In some examples, the format is specified by a Filetype in the Pathname of the URI. If an output operation, then at 816 output data is received at the electronic device from the external controller, and at 818 the output data is output from the electronic device in accordance with the applied parameter setting(s).

From the foregoing it will be appreciated that the electronic device and methods provided by the present disclosure represent a significant advance in the art. Device communication is greatly simplified in that communication to and from the device occurs via built-in communication methods present in any operating system, such as fileOpen, file Read, fileWrite, and fileClose methods. The communication with the device is standardized and homogenized between the different protocols and connection methods. Although several specific examples have been described and illustrated, the disclosure is not limited to the specific methods, forms, or arrangements of parts so described and illustrated. This description should be understood to include all novel and non-obvious combinations of elements described herein, and claims may be presented in this or a later application to any novel and non-obvious combination of these elements. The foregoing examples are illustrative, and no single feature or element is essential to all possible combinations that may be claimed in this or a later application. Unless otherwise specified, steps of a method claim need not be performed in the order specified. The disclosure is not limited to the above-described implementations, but instead is defined by the appended claims in light of their full scope of equivalents. Where the claims recite “a” or “a first” element of the equivalent thereof, such claims should be understood to include incorporation of one or more such elements, neither requiring nor excluding two or more such elements.

What is claimed is:

1. A method of controlling an electronic device, comprising:
receiving at the electronic device, from an external controller, a uniform resource identifier (URI);
parsing the received URI to determine a parameter setting for the electronic device defined by text of the URI; and
applying the determined parameter setting to the electronic device.

2. The method of claim 1,
wherein the URI includes a pathname, and
wherein the parsing includes parsing the pathname to determine the parameter setting.

3. The method of claim 2,
wherein the parameter setting comprises a plurality of individual parameter settings,
wherein the pathname comprises a plurality of directories, and
wherein the parsing includes parsing the pathname to determine at least one of the directories and a corresponding one of the individual parameter settings.

4. The method of claim 3, comprising:
the electronic device providing a directory structure to the external controller, the directory structure traversable by the external controller to construct the URI.

5. The method of claim 1, wherein the electronic device is an input device and wherein the pathname includes a filetype, the method comprising:
streaming input data from the electronic device to the external controller in a format specified by the filetype and in accordance with the applied parameter setting.

6. The method of claim 1, wherein the electronic device is an output device, the method comprising:
receiving output data at the electronic device from the external controller; and
outputting the output data from the electronic device in accordance with the applied parameter setting.

7. An electronic device, comprising:
an interface configured to receive, from an external controller, data packets corresponding to a uniform resource identifier (URI);
a protocol handler configured to convert the data packets into text of the URI;
a URI handler module configured to parse the text of the URI to determine a parameter setting for the electronic device; and
a device control module configured to apply the determined parameter setting to the electronic device.

8. The electronic device of claim 7, comprising:
a mechanism configured to perform a data-consuming or data-acquiring function of the electronic device, the device control module further configured to control the mechanism to perform the function.

9. The electronic device of claim 8, wherein the mechanism is configured to perform a data-acquiring function, the device control module further configured to format the acquired data in accordance with a filetype specified by the URI.

10. The electronic device of claim 7,
wherein the electronic device is a multi-function device configured to perform a plurality of different data functions, each data function performed by a different device control module, and
wherein the URI handler module is further configured to parse the URI to determine a specified data function and to invoke the corresponding one of the different device control modules to perform the specified one of the data operations.

11. The electronic device of claim 7, wherein the text of the URI specifies a parameter setting that is unsupported by the electronic device, and wherein the electronic device ignores the unsupported parameter setting or generates an error message to the external controller.

12. The electronic device of claim 7,
wherein at least one of the URI handler module and the device control module is further configured to define a set of permissible parameter settings, and
wherein the protocol handler is further configured to provide the set of permissible parameter values to the external controller as a directory structure.

13. The electronic device of claim 7,
wherein the URI comprises a pathname having a plurality of directories, each directory in the pathname corresponding to a setting for a different parameter, and
wherein the URI handler module is further configured to parse the pathname to determine each directory, each corresponding different parameter, and each parameter setting.

14. The electronic device of claim 7,
wherein the data packets correspond to disk sector blocks, and
wherein the protocol handler is further configured to implement a mass storage device protocol for communication with the external controller.

15. The electronic device of claim 7,
wherein the data packets are network packets, and
wherein the protocol handler is further configured to implement at least one of a server message block (SMB) protocol or a common Internet file system (CIFS) protocol for communication with the external controller.

16. The electronic device of claim 7,
wherein the data packets are network packets, and
wherein the protocol handler is further configured to implement a hypertext transfer (HTTP) protocol for communication with the external controller.

17. A method of controlling an electronic device, comprising:
traversing, via a browser of a computer, a directory structure provided by the electronic device, each directory in the structure corresponding to a set of parameter values for the electronic device;
at a particular directory in the structure, specifying an I/O operation for the electronic device; and
in response to the specifying, sending a uniform resource identifier (URI) to the electronic device, the URI having a pathname that defines the set of parameter values; and
configuring the electronic device with the set of parameter values and then performing the specified I/O operation.

18. The method of claim 17, wherein the specifying an I/O operation comprises:
selecting a file provided by the electronic device in the particular directory to specify an input operation.

19. The method of claim 17, wherein the specifying an I/O operation comprises:
storing a file from the computer into the particular directory to specify an output operation.

20. The method of claim 17, wherein no software specific to the electronic device is installed on the host computer.
